(19) United States
(12) Patent Application Publication
(10) Pub. No.: US 2015/0087416 A1
(43) Pub. Date: Mar. 26, 2015

(54) GAME PROGRAM, GAME APPARATUS AND GAME SYSTEM

(71) Applicant: CAPCOM CO., LTD., Osaka (JP)

(72) Inventors: Koshi Nakanishi, Osaka (JP); Hidehiro Goda, Osaka (JP)

(73) Assignee: CAPCOM CO., LTD., Osaka (JP)

(21) Appl. No.: 14/399,900

(22) PCT Filed: May 8, 2013
(86) PCT No.: PCT/JP2013/002948

§ 371 Date: Nov. 7, 2014

(30) Foreign Application Priority Data
May 8, 2012 (JP) 2012-106856

(51) Int. Cl. A63F 13/60; A63F 13/77

(52) U.S. Cl. CPC A63F 13/60; A63F 13/77
USPC 463/31

(57) ABSTRACT

Embodiments of the invention include, for example, computer-implemented methods, systems, computer devices and non-transitory computer-readable mediums having one or more computer programs stored therein to enable two or more players to play a virtual game simultaneously. Embodiments can include, for example, generating a first mission of a virtual game that is adapted to be played by a main character and a partner character, and generating a second mission that is adapted to be played by a liberty character after the start of the first mission by the main character. According to an embodiment of the invention, the first mission and second mission are adapted to be played simultaneously and without the main player being notified of the liberty character. The second mission is adapted to be played by the liberty character without interfering with the game play of the first mission.

### RELATED APPLICATIONS

This application is related to and claims priority and benefit to PCT/JP2013/002948 filed on May 8, 2013, titled (translated) “Game Program, Game Apparatus and Game System,” which claims priority and benefit to Japanese Patent Application No. 2012-106856 filed on May 8, 2012 titled to same, each of which is incorporated by reference in its entirety.

### TECHNICAL FIELD

Embodiments of the present invention relate to a game program that enables two or more players to play simultaneously.

### BACKGROUND OF THE INVENTION

A video game which can be played by a single player or also by two or more players cooperatively as a multiple-play game has been put into practical use. A game which has been started by one or more players and another player can participate in the middle, such as Japanese Patent No. 3317956, has also been provided.

### BRIEF SUMMARY OF THE INVENTION

In conventional multiple-play games, such as those mentioned in the Background of the Invention section above, when another player wants to participate in the game after it has started, the player needs permission by a player who has started playing the game previously. The player who participates in the game after it has started (such as in the middle of the game) also needs to play the game according to the aim or mission that has already been set by the player who has started the game previously. Embodiments of the invention include, for example, computer-implemented methods, systems, computer devices and non-transitory computer-readable mediums having one or more computer programs stored therein to enable two or more players to play a virtual game simultaneously.

As will be appreciated by those skilled in the art, embodiments of the invention improve the flexibility of a multi-player game and minimize the abruptness of conventional multi-player games by enabling a plurality of missions to be played by a plurality of users simultaneously, for example, without interrupting the mission of another player. Embodiments of the invention include, for example, a non-transitory gaming media having computer-readable instructions stored therein that enable two or more players to play a virtual video game simultaneously. The computer-readable instructions, when executed by one or more computer processors, are adapted to cause one or more computer processors to perform the steps of, for example: generating a first object in a virtual game space, actions of the first object in the virtual game space being at least in part responsive to first operational information generated by a first player from a first computing device; generating a second object in the virtual game space, actions of the second object in the virtual game being at least in part responsive to second operational information generated by a second player from a second computing device; generating a first mission of the virtual game that is adapted to be played by the first object; and generating a second mission that is adapted to be played by the second object, the second mission being independent of the first mission such that the first mission played by the first object is not interrupted by the second mission played by the second object when the second mission and the first mission are played simultaneously.

Embodiments of the non-transitory gaming media can further include instructions that cause one or more processors to perform the steps such as: generating a third object in the virtual game, actions of the third object in the virtual game being at least in part responsive to third operational information generated by a third player from a third computing device and the second operational information generated by the second player; and synchronizing gaming information of the virtual game so that the first mission is adapted to be played by the first object and the third object simultaneously. The second mission is adapted to be played by the second object independently from the first mission. According to one or more embodiments, the first player is not notified of the second mission when the second player is playing the second mission simultaneously with the first player and the third player playing the first mission of the virtual game.

Embodiments of the invention can also include, for example, a computer-implemented method of enabling two or more players to simultaneously play a virtual video game, the method comprising steps such as: generating, by one or more processors, a first object in a virtual game space, actions of the first object in the virtual game space being at least in part responsive to first operational information generated by a first player from a first computing device; generating, by one or more processors, a first mission of the virtual game that is adapted to be played by the first object; generating, by one or more processors, a second object in the virtual game space responsive to a request for participation from a second computing device, actions of the second object in the virtual game being at least in part responsive to second operational information generated by a second player from the second computing device; and generating, by one or more processors, a second mission that is adapted to be played by the second object, the second mission being independent of the first mission such that the first mission played by the first object is not interrupted by the second mission played by the second object when the second mission and the first mission are played simultaneously.

Embodiments of the invention can further include, for example, a gaming system adapted to enable two or more players to simultaneously play a virtual game. The system can include a main character gaming apparatus adapted to communicate operating information generated by a first player and a liberty character gaming apparatus adapted to communicate operating information generated by a second player.

Embodiments of a main character gaming apparatus can include, for example, a first main operation information unit adapted to receive first operation information generated by the first player using a main character gaming device; a first liberty object unit adapted to process information generated by a liberty character player using a liberty character gaming device; a first game space control unit adapted to generate a virtual game space for the first player; and a first main object control unit adapted to generate a main object in the virtual game space, the main object being at least in part responsive to first operational information generated by the first player using the main character gaming device.

Embodiments of the liberty character gaming apparatus can include, for example, a liberty operation information unit adapted to receive second operation information generated by the second player using a liberty character gaming device; a second main object unit adapted to process information generated by the main character player using the main character gaming device; a second game space control unit adapted to generate a virtual game space for the second player; and a liberty object control adapted to generate a liberty object in the virtual game space, the liberty object being at least in part responsive to second operational information generated by the second player using the liberty character gaming device, the liberty object being adapted to operate in the virtual game space simultaneously with the main character player without interfering with the main character player.

### BRIEF DESCRIPTION OF DRAWINGS

FIG. 1 is a block diagram of a game device according to an embodiment of the invention.

FIG. 2 is a diagram illustrating a game screen of a virtual game according to an embodiment of the invention.

FIG. 3 is a diagram illustrating activities of each character in the game according to an embodiment of the invention.

FIG. 4 is a diagram illustrating the participation of each player in the game according to an embodiment of the invention.

FIG. 5 is a functional block diagram of a game apparatus that is adapted to interoperate with the game device and a game program according to an embodiment of the invention.

FIG. 6 is a flowchart illustrating a processing of the game apparatus according to an embodiment of the invention.

FIG. 7A is a flowchart illustrating a processing of the game apparatus according to an embodiment of the invention.

FIG. 7B is a flowchart illustrating a processing of the game apparatus according to an embodiment of the invention.

### DETAILED DESCRIPTION OF THE EMBODIMENT

The present invention will now be described more fully hereinafter with reference to the accompanying drawings in which embodiments of the invention are shown. This invention may, however, be embodied in many different forms and should not be construed as limited to the illustrated embodiments set forth herein.

FIG. 1 is a block diagram of an electronic circuit of a game device 1 according to an embodiment of the invention. The game device 1 is a portable game device on which a display and keys are integrally provided. The game device 1 has a control unit 20, an operation unit 30, a media interface 31 and a wireless LAN communication unit 32 on the bus 26. The control unit 20 includes a CPU 21, a ROM (flash memory) 22, a RAM 23, an image processor 24 and a sound processor 25. The image processor 24 is connected to a video RAM (VRAM) 40 and the VRAM 40 is connected to a display unit 41. The display unit 41 includes a liquid crystal display and displays a game screen. The sound processor 25 is connected to an amplifier 42 including a D/A converter. The amplifier 42 is connected to a speaker 16 and an earphone jack 17.

The operation unit 30 has button switches such as A, B, C and D keys and a cross key (an arrow key), which may also have a touch panel formed on the display unit 41. The operation unit 30 detects the user's operation and generates an operation signal in response to the user's operation. The generated operation signal is communicated to the CPU 21.

A game media 5 is connected to the media interface 31 which is, for example, a memory card incorporating a flash memory. A game program 50 is stored in the game media 5 and includes not only the game program itself but game data such as an item image necessary for the game progress. The game media 5 may be a dedicated semiconductor for the game device 1, a general-purpose semiconductor memory, or an optical disk and the like.

In the RAM 23, a working area that is used when the CPU 21 executes the game program 50 is set. Various parameters such as a parameter related to a player character PC controlled in the game device 1 are saved in the working area. A basic program to execute the game program 50 in the game device 1 is stored in ROM 22, which is a flash memory. A downloaded application program can be saved in the ROM 22 as well as the basic program.

The image processor 24 has a Graphics Processing Unit (GPU) that generates a game image. The image processor 24 generates a game space according to computer-executable instruction executed by the CPU 21 and renders an image obtained by photographing the game space with a virtual camera as a game image on the VRAM 40.

The sound processor 25 has a Digital Signal Processor (DSP). With the DSP, the sound processor 25 generates a sound signal such as game sound and reproduces sound signal waveform data. The generated or reproduced sound signal is input into the amplifier 42, which amplifies and outputs the input sound signal to the sound speaker 16 and the earphone jack 17.

The wireless communication unit 32 has a digital communication circuit for 2.4 GHz band, for example, and performs internet communication via wireless access point and direct communication with another game device 1 using the digital communication circuit. The direct communication with another game device 1 is called local communication. The internet communication is performed over IEEE802.11g standard (what is called “Wi-Fi”); on the other hand, the local communication is performed over an ad hoc mode of IEEE802.11b or its own standard.

The local communication is used for the local play wherein the game device 1 communicates directly with another game device 1 using the local communication and a plurality of the game devices 1 play the same game. The situation wherein a plurality of the game devices 1 perform the same game is sometimes called “multiple-play”, for example. In a multiple-play game, user of each game device 1 can fight each other and/or engage in cooperation play wherein the user of each game device 1 become friends and play the game together.

According to an embodiment of the invention, internet communication is used for the internet play and to download the program. The internet play is the game performing formation, wherein a plurality of the game devices 1 perform the same game by a game device 1 communicating with another game device 1 via the internet. The internet play is also a multiple-play.

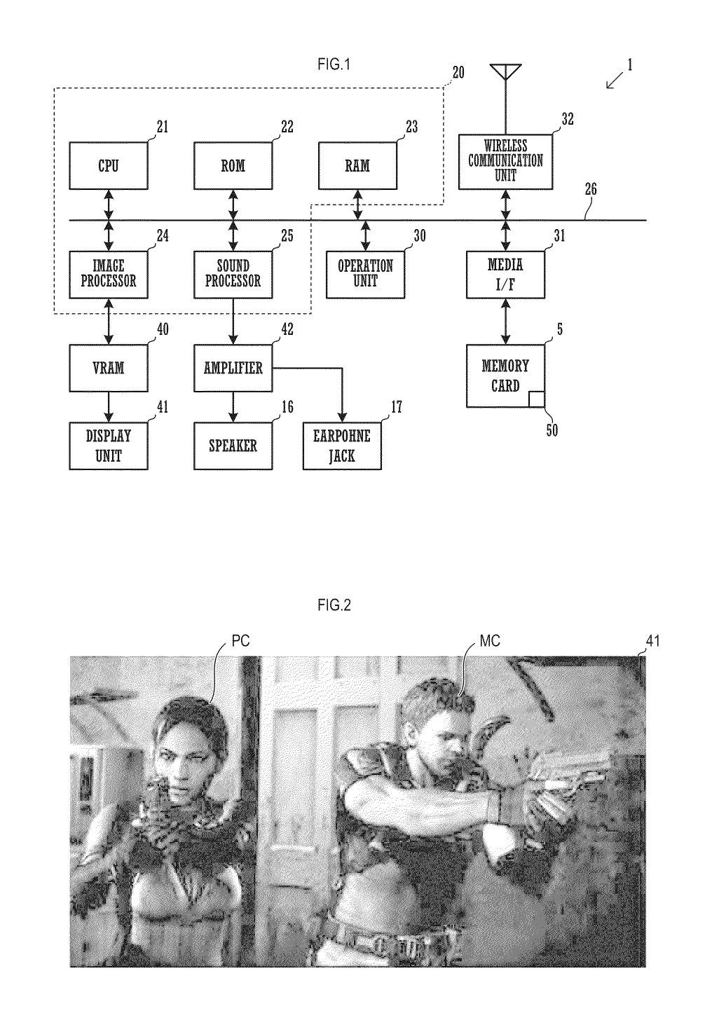

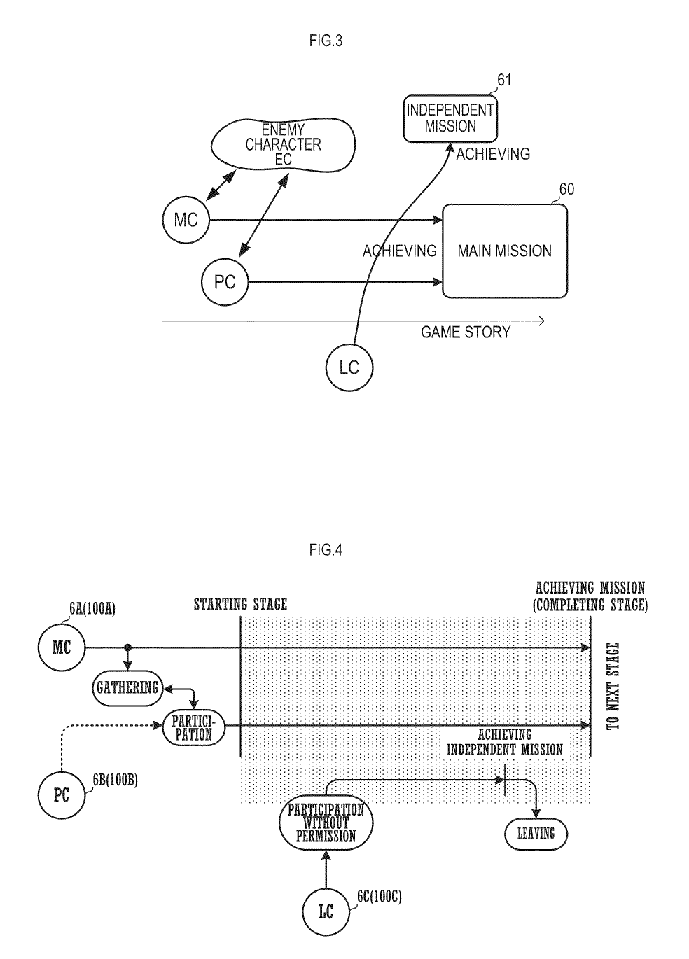

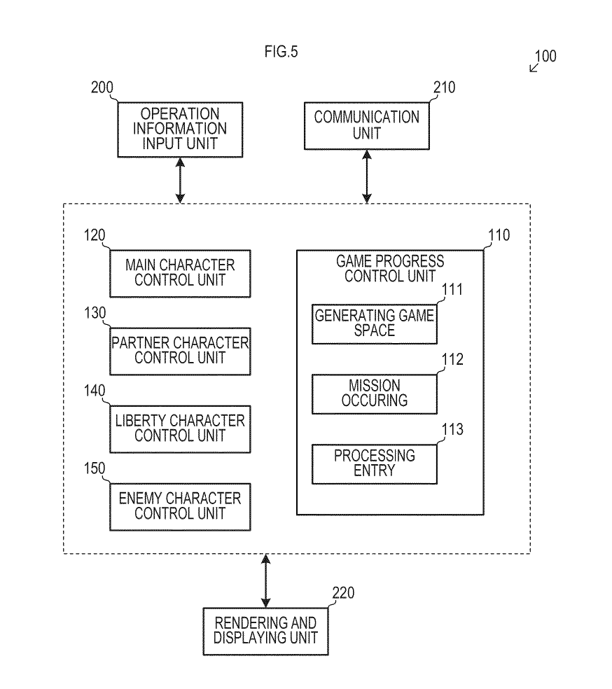

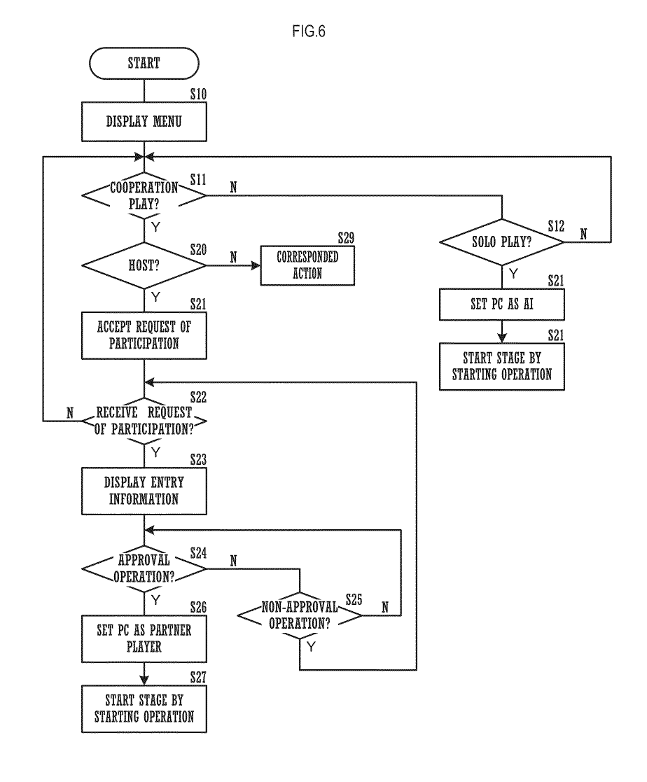

FIG. 5 is a functional block diagram of a game apparatus 100 that is adapted to interoperate with the game device and a game program according to an embodiment of the invention. According to an embodiment of the invention, the game device 1 is a game apparatus 100 illustrated in FIG. 5 in conjunction with the game program 50. The game performed by the game apparatus 100 is what a main character MC and a partner character PC aim at completing. As illustrated in FIGS. 2, 3 and 4, the main character MC and partner character PC cooperate with each other to complete one or more main missions 60 of the game. FIG. 2 illustrates an example of the game screen generated by the game apparatus 100 according to an embodiment of the invention. FIG. 3 is a diagram illustrating a form of activities of the main character MC, the partner character PC, and a liberty character LC in the game. FIG. 4 is a diagram illustrating a lapse of time of the game performed by the game apparatus 100, and FIG. 5 is a functional block diagram of the game apparatus 100 according to an embodiment of the invention.

The main character MC is operated by a main player 6A who is a user of the game apparatus 100 (a host 100A), which means the main character MC is a player character. The partner character PC may be a non-player character made to act by automatic control of the host 100A without the player's operation and may also be operated by a partner player 6B who is a user of another game apparatus 100 (a guest 100B). The local communication or the internet communication may be used for the communication with the guest 100B.

An enemy character EC that fights with the main character MC and the partner character PC is also in the game. However, the enemy character EC is a non-player character acting by automatic control of the game apparatus 100 (the host 100A and the guest 100B) without the player's operation.

According to an embodiment of the invention, the liberty character LC appears on the game space in a liberty character mode. The liberty character LC is a player character whose action is controlled by the game apparatus 100C of the liberty player 6C, the user of another game apparatus 100 (a guest 100C), which is different from the game apparatus 100A controlled by the main player 6A and the game apparatus 100B controlled by the partner player 6B. The liberty character LC enters the game progress (the game space) of the main player 6A and the partner player 6B at any time without notification to the main player 6A and the partner player 6B and plays one or more independent missions 61. The independent mission 61 is played by the liberty player 6C after the start of the game and without interrupting the play of the main player 6A or the partner player 6B play of the main mission 60. According to an embodiment of the invention, when the independent mission is completed, the liberty character LC leaves the game space without notifying the main player 6A or the partner player 6B. After completing the independent mission, the liberty character LC may also not be made to leave the game, for example, and can act freely until the main mission is achieved.

Embodiments of the invention improve the player's interest in the game and the degree of freedom on how to participate in the game. Additionally, embodiments of the invention also minimize the interruptions of the game play by preventing the liberty character LC from interfering with the main mission played by the main character MC. Embodiments of the invention improve the unexpectedness and the flexibility of the multiple-play game.

Referring to FIG. 3, the main character MC and the partner character PC seek to complete the main mission 60 by cooperating with each other, for example, and by fighting with the enemy character EC. On the other hand, the liberty character LC participates in the game (appears on the same game space) with an aim different from the main character MC's and the partner character PC's. The liberty character LC seeks to complete the independent mission 61, which is different from the main mission 60 that is given to the main character MC and the partner character PC.

According to an embodiment of the invention, the independent mission 61 is a mission that does not change the story of the game or that makes it impossible to complete the main mission 60 by the main character MC or the partner character PC while they remain alive during the game. However, the independent mission 61 may affect the game progress directly or indirectly. Examples of the independent mission 61 which hardly affect the game progress of the main character MC and the partner character PC are such as “Retrieve a sample of viruses”, “Do not be found by anyone” and the like. When the independent mission 61, “Do not be found by anyone” is given for example, the liberty player 6C tries not to be found by the main player 6A and the partner player 6B, for example, by operating the liberty character LC not to enter a range of a virtual camera set in the game space.

Examples of the independent mission 61 that affect the game progress indirectly, include, for example, cooperative missions such as “Do not make the main character MC die”, “Defeat 10 enemy characters EC” and a surprise mission such as “Kill the main character MC”. According to certain embodiments, the independent mission 61 is the same as the main mission 60. Even in these certain embodiment, the existence of the liberty character LC (the liberty player 6C) or the mission for the liberty character LC is not informed to the main player 6A so that it becomes a game play different from the normal play.

In the liberty character mode it may be possible to set permission for only a cooperative mission occurring as the independent mission 61 by the main player 6A's setting.

The independent mission 61 given to the liberty player LP may also be determined at random or be selected by the liberty player 6C.

Except in the case in which the independent mission 61 is to meet the main character MC and the partner character PC such as in a cooperative mission and the fighting mission is given, the liberty character LC may hide and act not to meet the main character MC and the partner character PC. In that case, the main character MC and the partner character PC may play the game without noticing the liberty character LC and the liberty character LC may not be noticed by the main character MC and the partner character PC from appearing on the game to leaving the game. It is not essential to hide from the main character MC and the partner character PC as long as that is not the mission itself. The liberty character LC can appear on the view field of the main character MC and the liberty character LC.

When the liberty character LC appears on the view field of the main character MC and the partner character PC, some markers may be added to the liberty character LC to be found at a glance or the liberty character LC can be indistinguishable from the enemy character EC. The appearance of the liberty character LC may be unique to the liberty character LC or it may be similar to the appearance of the main character MC, the partner character PC or the enemy character EC.

The sudden appearance of the liberty character LC can give the main player 6A and the partner player 6B surprise and cause changes to the game play. Further, if the character does not appear in sight, sound of gunshots, footsteps and the like makes the main player 6A and the partner player 6B think that someone is there, which also changes the feeling of the game play.

FIG. 4 shows a flow of the game when the liberty character mode is permitted in the multiple-play game. The main player 6A starts the game apparatus 100 to start the game and sets the multiple play in the game apparatus 100. Thus, the game apparatus 100 becomes a host 100A and performs the game communicating with a guest 100B. The main player 6A also sets the liberty character mode (e.g., the host 100A is set to permit the liberty character LC to participate in the game).

The host 100A gathers the partner player 6B that is the guest 100B via the local communication or the internet and starts the game stage after the partner player 6B (the guest 100B) has participated. According to an embodiment of the invention, approval by the main player 6A is needed for the participation of the partner player 6B (the guest 100B). Alternatively, the partner player 6B (the guest 100B) is able to participate without the approval of the main character. In the stage, the main character MC and the partner character PC cooperate with each other to reach a stage of the game by completing one or more main missions 60. During the stage being performed, according to an embodiment of the invention, the host 100A transmits the information that it is in the liberty character mode via the local communication or the internet.

The information is received by the liberty guest 100C that is the game apparatus 100 of the liberty player 6C. The liberty guest 100C notifies the liberty player 6C that the host 100A is in the liberty character mode. The liberty player 6C sends a request of participation as the liberty player 6C to the host 100A operating the liberty guest 100C. In response to the request of participation, the host 100A generates the liberty character LC and makes it appear on the game. The liberty character LC is controlled to act by the liberty guest 100C, which controls the liberty character LC on the basis of the operation of the liberty player 6C. In this case, a present position of the main character MC and the partner character PC is obtained and the liberty character LC appears wherein it is out of the range of the virtual camera and separated from the main character MC and the partner character PC by a predetermined distance. The game is also performed in the liberty guest 100C in synchronization with the host 100A. The host 100A may reject connection or participation to the request of the participation by the liberty player 6C (the liberty guest 100C) without the main player 6A's operation.

When the liberty player 6C appears in the game space, at least one of: “participation of the liberty character LC”, “a timing that the liberty character participates” and “an objective of the liberty character LC'S independent mission 61” is not known to at least one of the main player 6A who operates the main character MC and the partner player 6B who operates the partner character PC.

If “participation of the liberty character LC” is not enabled, a player who is not notified (e.g., the main player 6A and/or the partner player 6B) needs to play the game without knowing the participation of the liberty character LC. If “a timing that the liberty character participates” is not enabled, a player who is not notified needs to play the game without knowing when the liberty character LC appears on the game. And if “an objective of the liberty character LC'S independent mission 61” is not enabled, a player who is not notified needs to play the game without knowing how the liberty character acts in the game space. Those make it possible to give the game progress changes.

Thereafter, the host 100A, the guest 100B and the liberty guest 100C perform the game in synchronization. The main character MC and the partner character PC are given the main mission 60 along with the game story in the same way as performing the game only between the host 100A and the guest 100B and prompted to complete the stage. The independent mission 61 to achieve is given to the liberty character LC in the same game space.

When the liberty character LC achieves the given independent mission 61, the role of the liberty character LC comes to an end and the liberty character LC leaves the game. According to an embodiment of the invention, the liberty character LC vanishes from the game space and the communication of the liberty guest 100C with the host 100A and the guest 100B also terminates.

The liberty character can act until the independent mission 61 is achieved or an active value HP of the liberty character LC becomes 0. In the case in which the main character MC or the partner character PC completes the stage or the main character MC and/or the partner character PC dies and the game is over, the independent mission 61 cannot be achieved and the game for the liberty character is over if the active value HP of the liberty character LC does not yet become 0.

According to an embodiment of the invention, if the independent mission 61 is completed, a reward is given to the liberty character LC (the liberty player 6C). The reward may be set to give the main character MC or the partner character PC when the main character MC (the main player 6A) or the partner character PC (the partner player 6B) prevents the independent mission of the liberty character LC or the liberty character LC fails in the independent mission 61.

Also, when the main character MC (the main player 6A) or the partner character PC (the partner player 6B) completes or fails in the main mission 60, existence of the liberty character LC, an objective of the liberty character LC's independent mission 61 or its success or fail information may be known to the main character MC and/or partner character.

FIG. 5 is a functional block diagram showing the game apparatus 100 performed by the game device 1 (hardware) and the game program 50 in the game media 5 being loaded in the game device 1. As will be understood by those skilled in the art, one or more of the units illustrated in FIG. 5 can be implemented using one more computer program modules. The game apparatus 100 has a game progress control unit 110, a main character control unit 120, a partner character control unit 130, a liberty character control unit 140, an enemy character control unit 150, an operation information input unit 200, a communication unit 210 and a rendering and displaying unit 220. The operation information input unit 200 is performed by cooperation among the control unit 20, the operation unit 30 and the game program 50. The rendering and displaying unit 220 is performed by cooperation among the control unit 20, the VRAM 40, the display unit 41 and the game program 50. The game progress control unit 110, the main character control unit 120, the partner character control unit 130, the liberty character control unit 140 and the enemy character control unit 150 are performed by cooperation between the control unit 20 and the game program 50. The game progress control unit 110 comprises a game space generating unit 111, a mission generating unit 112 and an entry processing unit 113.

The operation data input unit 200 takes in an operation signal generated by user's operation of the operation unit 30 and inputs it as an operation data into the game progress control unit 110. The communication unit 210 communicates with other game apparatuses 100 such as a game apparatus 100B or a game apparatus 100C and receives operation information operated by a user of the other game apparatuses 100 such as the partner player 6B or the liberty player 6C. The communication unit 210 also sends and receives data to synchronize the game in each game apparatus.

The game is progressed by the game progress control unit 110 on the basis of the operation information that is input from the operation information unit 200 or the communication unit 210. The game space generating unit 111 generates the game space and gradually changes the game space according to the operation information and/or a lapse of time. The mission generating unit 112 generates and presents the missions to the main character MC, the partner character PC and the liberty character LC. The mission generating unit 112 generates the main mission 60 to the main character MC and the partner character PC to complete a stage of the game on the basis of the game story. The main mission 60 is a condition to complete the stage and progress the game for the main character MC and the partner character PC. The game progress control unit 110 determines whether the main character MC and the partner character PC achieves the main mission 60 or not and controls the game progress on the basis of the result of the decision. The mission generating unit 112 also generates the independent mission 61 for the liberty character LC, which is a condition to obtain points and leave the game for the liberty character LC.

The entry processing unit 113 accepts the entry from the game apparatus 100B or the liberty guest 100C and inputs the operation information which is sent from the game apparatus 100B into the partner character control unit 130 and the operation information which is sent from the liberty guest 100C into the liberty character control unit 140.

Each of the main character control unit 120, the partner character control unit 130 and the liberty character control unit 140 generates a character in charge respectively and makes the character act in the game space on the basis of each operation information. In solo play, the partner character control unit 130 automatically generates the operation information with artificial intelligence (AI) function, as understood by those skilled in the art, to cause the non-player character to act. Also the enemy character control unit 150 generates the enemy character EC and makes the enemy character act in the game space on the basis of the operation information which is automatically generated with artificial intelligence (AI) function.

FIG. 6 is a flowchart showing a process to determine the play mode performed by the game apparatus 100 when starting the game according to an embodiment of the invention. When the game is launched by the user's operation, the menu screen is displayed at first (Step 10) (Step hereinafter referred to as “S”). On the menu screen, select buttons for the solo play, the local play or the internet play are displayed. The user can select the play mode by touching a desired button.

If the cooperation play is selected (YES in S11), the processing step goes to S20. Cooperation play can use a local connection and/or the internet to communicate. If the solo play is selected (YES in S12), the processing step goes to S13. In S13, control of the partner character PC is set to artificial intelligence (AI) (S13) and the stage starts according to the starting operation.

In S20, the selection whether the game apparatus 100 starts up the game session of itself and gathers the partner player 6B (the cooperation game apparatus 100B) as the host 100A or participates in the session which is started up by another host 100A as the guest 100 B is accepted (S20). If the participating in another session as the guest 100B is selected (NO in S20), the processing step goes to a corresponded action (S29).

If gathering the partner player 6B as the host 100A is selected (YES in S20), the request of participation from the partner player 6B is accepted (S21). If the request of participation is received (YES in S22), entry information of the user of the game apparatus 100 is sent from the game apparatus 100 that has requested participation so that the entry information is displayed on the display unit 140 (S23) and operation for approval/non-approval by the user (the main player 6A) is accepted (S24, S25). The main player 6A determines whether to approve the participation or not by the entry information. When the approval operation is performed by the main player 6A (YES in S24), the player who requested the participation is set as the partner player 6B who operates the partner character PC (S26), which is sent to the guest 100B, and then the stage is started according to the start operation (S27). On the other hand, if operation of non-approval for the participation is performed by the main player 6A (S25), a message of non-approval is sent to the game apparatus 100 which sent the request of participation and another request of participation is accepted returning to S22. Thus, gathering the partner player 6B at the time of starting the game is set that approval by the main player 6A is as a condition.

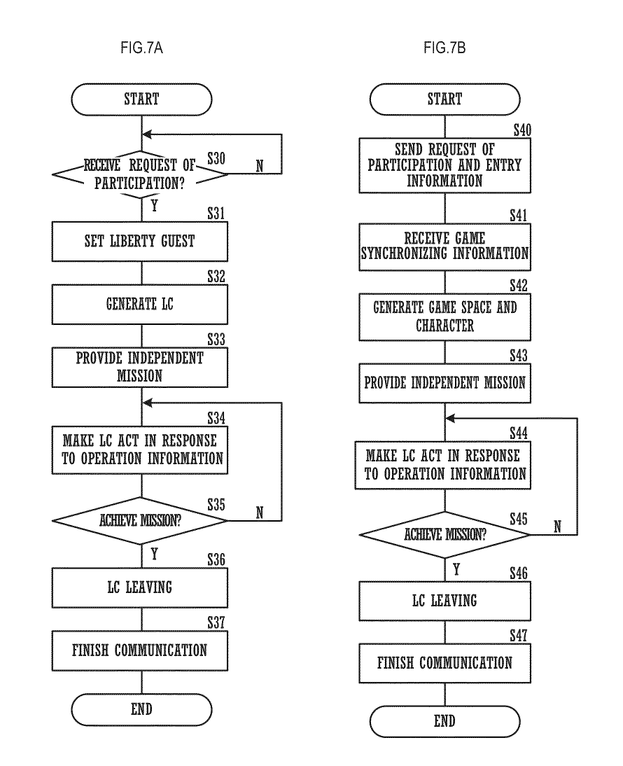

FIG. 7A is a flowchart showing processing of the host 100A which corresponds to a request of participation from the liberty guest 100C after the start of the game. The processing step waits at S30 until participation is requested. If the request of participation from another game apparatus 100 is received (YES in S30), the game apparatus 100 is set as the liberty guest 100C (S31). For this setting, a message which shows approval of the request of participation and synchronization information of the game to synchronize the game progress of the liberty guest 100C to the host 100A are replied to the game apparatus 100.

Subsequently, the liberty character LC is generated in the game space (S32), which is operated by the liberty guest 100C (the liberty player 6C). The independent mission 61 that does not directly affect the story is generated and provided to the liberty character LC (S33), which is made to act in the game space according to the operation information input from the liberty guest 100C (S34). This activity is possible until the liberty character LC achieves the independent mission 61 (S35), the active value HP of the liberty character LC becomes 0 or the stage which is currently performed is over (S35). If the liberty character LC achieves the independent mission 61 (YES in S35), the liberty character LC is made to leave the game space (S36) and the communication with the liberty guest 100C is finished (S37).

FIG. 7B is a flowchart showing processing of the liberty guest 100C that has sent the request of participation to the host 100A. If the host 100A that permits the liberty character mode is detected via the local communication or the internet, the user (the liberty player 6C) operates to request participation to the host 100A. In accordance with the operation for requesting participation, the liberty guest 100C sends the entry information to the host 100A (S40). In response to the entry information, information to synchronize the game progress (game synchronization information) is received (S41), and on the basis of the information, the game space and the characters such as the liberty character LC, the main character MC, the partner character PC, the enemy character EC and the like are generated (S42) and the game is progressed in synchronization with the host 100A (and the guest 100B). Then the independent mission 61 to the liberty character LC is generated in synchronization with the host 100A (S43). The liberty character LC is made to act in the game space in response to the operation information which is input from the operation unit 30 (S44). If the liberty character LC achieves the independent mission 61 (S45), the liberty character LC is made to leave the game (S46), the communication with the host 100A is finished (S47) and the game by the LC entry is finished.

The host 100A, the guest 100B and the liberty guest 100C regularly synchronize the game progress by communicating with each other, for example, in each 1 frame.

In explaining above, the case in which the liberty player 6C participates in the multiple play game is explained, however, the liberty player 6C participating in solo play is also included in one or more embodiments of the invention. The liberty character LC may appear on the game without the partner character (e.g., the game in which only the main character MC is acting).

According to an embodiment of the invention, the host 100A, the guest 100B and the liberty guest 100C are adapted to communicate with each game device 1 (each game apparatus 100). According to another embodiment of the invention, a server may be used to facilitate the video game and communicate with the host 100A, the guest 100B, and the liberty guest 100C.

According to an embodiment, a plurality of the characters fight with each other in a game. Embodiments of the invention, however are not limited to the characters or kind of games described above. For example, embodiments of the invention can include racing games or other games that include vehicles, or a space ship, and can also include other action-adventure or mystery games.

1-7. (canceled)

8. A non-transitory gaming media having computer-readable instructions stored therein that enable two or more players to play a virtual video game simultaneously, the instructions stored in the media adapted to cause one or more computer processors to perform the steps of:
generating a first object in a virtual game space, actions of the first object in the virtual game space being at least in part responsive to first operational information generated by a first player from a first computing device,
generating a second object in the virtual game space, actions of the second object in the virtual game space being at least in part responsive to second operational information generated by a second player from a second computing device,
generating a first mission of the virtual game space that is adapted to be played by the first object, and
generating a second mission that is adapted to be played by the second object, the second mission being independent of the first mission such that the first mission played by the first object is not interrupted by the second mission played by the second object when the second mission and the first mission are played simultaneously.

9. The non-transitory gaming media as defined in claim 8, wherein the instructions further cause the one or more computer processors to perform the steps of:
generating a third object in the virtual game space, actions of the third object in the virtual game space being at least in part responsive to third operational information generated by a third player from a third computing device and the second operational information generated by the second player.

10. The non-transitory gaming media as defined in claim 9, wherein the instructions further cause the one or more computer processors to perform the steps of:
synchronizing gaming information of the virtual game space so that the first mission is adapted to be played by the first object and the third object simultaneously, and
wherein the second mission is adapted to be played by the second object independently from the first mission such that the first player and the third player are not notified of the second mission when the second player is playing the second mission simultaneously with the first player and the third player playing the first mission of the virtual game space.

11. The non-transitory gaming media as defined in claim 8, wherein the instructions further cause the one or more computer processors to perform the steps of:
generating a third object in the virtual game space, actions of the third object in the virtual game space being at least in part responsive to third operational information automatically generated by the virtual game space and the second operational information generated by the second player, and
synchronizing gaming information of the virtual game space so that the first mission is adapted to be played by the first object and the third object simultaneously.

12. A computer-implemented method of enabling two or more players to simultaneously play a virtual video game, the method comprising the steps of:
generating, by one or more processors, a first object in a virtual game space, actions of the first object in the virtual game space being at least in part responsive to first operational information generated by a first player from a first computing device,
generating, by one or more processors, a first mission of the virtual game space that is adapted to be played by the first object,
generating, by one or more processors, a second object in the virtual game space responsive to a request for participation from a second computing device, actions of the second object in the virtual game space being at least in part responsive to second operational information generated by a second player from the second computing device, and
generating, by one or more processors, a second mission that is adapted to be played by the second object, the second mission being independent of the first mission such that the first mission played by the first object is not interrupted by the second mission played by the second object when the second mission and the first mission are played simultaneously.

13. The computer-implemented method as defined in claim 12, the method further comprising:
generating a third object in the virtual game space, actions of the third object in the virtual game space being at least in part responsive to third operational information generated by a third player from a third computing device and the second operational information generated by the second player.

14. The computer-implemented method as defined in claim 13, the method further comprising:
synchronizing gaming information of the virtual game space so that the first mission is adapted to be played by the first object and the third object simultaneously,
wherein the second mission is adapted to be played by the second object independently from the first mission such that the first player and the third player are not notified of the second mission when the second player is playing the second mission simultaneously with the first player and the third player playing the first mission of the virtual game space.

15. The computer-implemented method as defined in claim 12, the method further comprising:
generating a third object in the virtual game space, actions of the third object in the virtual game space being at least in part responsive to third operational information automatically generated by the virtual game space and the second operational information generated by the second player, and
synchronizing gaming information of the virtual game space so that the first mission is adapted to be played by the first object and the third object simultaneously.

16. A gaming system adapted to enable two or more players to simultaneously play a virtual game, the system comprising:
a first gaming apparatus adapted to communicate operating information generated by a first player to thereby define a main character gaming apparatus, the main character gaming apparatus comprising:
a first main operation information unit adapted to receive first operation information generated by the first player using a main character gaming device,
a first liberty object unit adapted to process information generated by a liberty character player,
a first game space control unit adapted to generate a virtual game space for the first player, and
a first main object control unit adapted to generate a main object in the virtual game space, the main object being at least in part responsive to first operational information generated by the first player using the main character gaming device; and
a second gaming apparatus adapted to communicate operating information generated by a second player to thereby define a liberty character gaming apparatus, the liberty character gaming apparatus comprising:
a liberty operation information unit adapted to receive second operation information generated by the second player using a liberty character gaming device,
a second main object unit adapted to process information generated by the first player using the main character gaming device,
a second game space control unit adapted to generate the virtual game space for the second player, and
a liberty object control adapted to generate a liberty object in the virtual game space, the liberty object being at least in part responsive to second operational information generated by the second player using the liberty character gaming device, the liberty object being adapted to operate in the virtual game space simultaneously with the first player without interfering with the first player.

17. The system as defined in claim 16, wherein the main character gaming apparatus further comprises:
a first partner operation information unit adapted to receive a request for a partner character to participate in the virtual game space,
a first partner object control unit adapted to generate a partner object in the virtual game space, the partner object being at least responsive to the first operational information generated by the first player using the main character gaming device.

18. The system as defined in 17, wherein the liberty character gaming apparatus further comprises:
a second partner object unit adapted to process information generated by the partner character.

19. The system as defined in 17, wherein the partner character is generated responsive to operational information automatically generated by the virtual game space.
